(19) United States
(12) Patent Application Publication
(10) Pub. No.: US 2025/0194627 A1
(43) Pub. Date: Jun. 19, 2025

(54) DRY COFFEE BEAN SUBSTITUTE

(71) Applicant: NORTHERN WONDER HOLDING B.V., Ede (NL)

(72) Inventor: Onno FRANSE, Ede (NL)

(73) Assignee: NORTHERN WONDER HOLDING B.V., Ede (NL)

(21) Appl. No.: 18/849,845

(22) PCT Filed: Mar. 20, 2023
(86) PCT No.: PCT/NL2023/050143

§ 371 Date: Sep. 23, 2024

(30) Foreign Application Priority Data
Mar. 22, 2022 (NL) 2031365
Apr. 15, 2022 (NL) 2031602

(51) Int. Cl. A23F 5/44; A23F 5/46; A23L 2/395

(52) U.S. Cl. CPC A23F 5/44; A23F 5/465; A23L 2/395

(57) ABSTRACT

The present invention is in the field of coffee substitutes, a method of preparations thereof, and use of such a coffee substitute, in particular a coffee substitute in the form of a bean. Coffee substitutes are non-coffee products, that is of origin other than from a coffee bean or the like, which may be provided with or without caffeine, that are intended to imitate coffee. The coffee substitute can for instance be used as a filter substitute, a pour over/drip substitute, a French press substitute, a percolate substitute, and an espresso substitute.

### FIELD OF THE INVENTION

The present invention is in the field of coffee substitutes, a method of preparations thereof, and use of such a coffee substitute, in particular a coffee substitute in the form of a bean. Coffee substitutes are non-coffee products, that is of origin other than from a coffee bean or the like, which may be provided with or without caffeine, that are intended to imitate coffee. The coffee substitute can for instance be used as a filter substitute, a pour over/drip substitute, a French press substitute, a percolate substitute, and an espresso substitute.

### BACKGROUND OF THE INVENTION

The present invention relates in general to a coffee substitute. Coffee substitutes are obtained from plant materials other than coffee. They may comprise caffeine or not, which caffeine can be added. Clearly coffee substitutes are intended to imitate coffee, mainly in view of taste and fragrance, but also in terms of appearance. Typically only one type of plant material is used as coffee substitute. For instance, roasted grain beverages are common substitutes for coffee. Other examples are acorns, chicory, and molasses. It is noted that obtaining a coffee substitute that closely mimics the characteristics of genuine coffee is still difficult. The substitutes themselves may also be considered as a base for a hot aromatic drink.

Coffee substitutes have been around since the 18^{th} century. These substitutes were mainly developed in periods when coffee supply was limited and affordability was low. The driver behind that development was thus the low availability and high price of coffee itself. Some of these substitutes have found their niche in the current marketplace, like chicory, barley, as well as blends. These products do not contain caffeine, do not really taste similar to coffee, and cannot be brewed in all traditional or modern coffee methods and equipment.

The cultivation of coffee plants is however land occupation intensive. Also coffee plants can only be grown in limited climatological regions. Typically coffee crops compete with existing nature, such as tropical rain forest. The increase in coffee demand is prone to come at the cost of less rain forest. It is noted that coffee growth is in size the sixth cause of deforestation. Further, in view of climate change, coffee often has to be cultivated at higher altitudes, compared to previous decades, which comes at the costs of sacrificing even more land. Also cultivation of coffee involves rather large amounts of water. In particular tropical regions are therefore prone to losing valuable natural resources.

Incidentally reference can be made to CN 113 749 202 A, CN 107 333 958 A, and EP 0 264 789 A2. CN 113 749 202 A recites a solid beverage and a preparation method thereof. The preparation method comprises the following steps that raw materials are sequentially subjected to superfine grinding, fermentation, Maillard reaction, baking and extrusion granulation, and the solid beverage is obtained, wherein the raw materials comprise any one or more of Taraxacum mongolicum Hand.-Mazz. roots, Cichorium intybus L. roots or ganoderma. Any one or more of the Taraxacum mongolicum Hand.-Mazz. roots, the Cichorium intybus L. roots or the ganoderma are subjected to the superfine grinding, the fermentation, the Maillard reaction, the baking, the extrusion granulation and other steps, most of nutrient ingredients of the preparation raw materials can be reserved, the beverage which is exactly similar to traditional coffee and is good in color, fragrance, bitter taste and sour taste is obtained, the traditional Chinese medicine taste of Taraxacum mongolicum Hand.-Mazz. is eliminated, and side effects caused by caffeine are avoided. In the preparation process, extraction and concentration are not needed, especially, granulation can be carried out without adding any excipient and solvent, the technology is simple, the processing cost is low, and the defects that the technology and the equipment of similar products are complicated, and the taste of traditional Chinese medicines cannot be eliminated are overcome. CN 107 333 958 A recites a method for preparing a coffee beverage substitute by utilizing soybeans, and belongs to the field of new utilization of bean product processing. The method comprises the following steps: (1) soaking soybeans in water, then putting the soybeans into an incubator for germination culture, and drying the soybeans; (2) respectively pouring the dried soybeans and wheat germ into a rotary roaster for roasting, then coarsely crushing the soybeans, removing soybean hulls, and crushing the soybeans by using a high-speed crusher; (3) compounding the crushed soybean meal and wheat germ meal according to the mass ratio of 1:1, sieving the compounded meal, and pouring the sieved compounded meal into an intermeshing co-rotating twin screw extruder for extrusion and puffing; and (4) crushing the material subjected to extrusion and puffing, homogenizing the material, and then carrying out spray drying so as to obtain soybean ground coffee. The method applies the germination treatment and roasting compounded technology and is simultaneously matched with the high-temperature extrusion and puffing technology to produce material meal with coffee color and taste, and the method finally cooperates with the spray drying technology to prepare a coffee substitute which has good instant solubility, high nutritional values and good market prospects. EP 0 264 789 A2 recites a process wherein plant materials are converted into substances suitable for direct human consumption, or from the plant materials, substances with a different aroma are produced. The plant materials are heated in a high-speed extruder with exclusion of air in less than 5 seconds to a temperature of 150 to 500° C. The process is especially suitable for the production of coffee substitute from cereals, or for the production of an aromatised substance from soya meal, which, as an example, by mixing with fat and salt, can be made into a peanut butter substitute.

The present invention therefore relates to an alternative coffee substitute, which solves one or more of the above problems and drawbacks of the prior art, providing more reliable results, without jeopardizing functionality and advantages.

### SUMMARY OF THE INVENTION

It is an object of the invention to overcome one or more limitations of the prior art and provide a coffee substitute in particular of non-tropical plant ingredients. The present invention provides coffee substitutes of at least one roasted extrudate, the extrudate comprising mainly plant material, in particular a mixture of plant materials, such as >90 wt. % plant material, and optional further ingredients, such as 0-10 wt. % of material from or produced by microorganisms, in particular bacteria, fungi, and prokaryotes, or parts thereof, such as enzymes, and 0-10 wt. % of at least one chemical compound, in particular wherein the extrudate is made from non-tropical ingredients, of which the taste is quite similar to coffee, which can be brewed similar to coffee, and are provided with and without caffeine. The present invention is based on very thorough analytical and sensory R&D on coffee and its potential alternative ingredients in all stages of the process, enabling to re-engineer a coffee bean substitute by using extrusion technology in combination with innovative blends of non-tropical ingredients. In particular use is made of a combinations of at least two of such plant ingredients, in particular wherein the at least two plant ingredients belong to different plant families. By making use of non-tropical ingredients not only the pressure on tropical forest may be reduced, but also overall water-consumption, transport energy, and transport costs may be reduced. The present invention relates to a blend of plant ingredients, which when blended carefully, and prepared accordingly, are considered to provide a good coffee substitute, in particular in terms of flavours, in particular aromas, taste, and fragrances. In particular the present coffee bean substitute of at least one roasted extrudate provides good coffee flavours, in particular aromas, taste, and fragrances, upon extraction thereof, comparable with natural coffee extracts. It is found that the intimate mixing and blending, before extruding and roasting leads to much better mutual Maillard reactions which lead to an improved coffee substitute. In addition it is found that the extractability of ingredients from the raw materials is improved when brought together. Also caramelization and pyrolysis of the ingredients is improved. It is noted that taste, scent, mouth feel, and so on, on the one hand, and molecules being present and being released, on the other hand, are closely related. In particular, the present coffee bean can be treated as a normal coffee bean, as it is roasted and prepared as such. The present coffee been substitute can be ground as a normal coffee bean, and then extracted using water. In particular the flavours, in particular aromas, taste, and fragrances of the extract mimic a normal coffee extract very much. In order to obtain a dry coffee bean substitute the present inventors have developed a substitute comprising >90 wt. % of at least one roasted extrudate in particular of at least one homogenized blend of at least two non-tropical ingredients, in particular >95 wt. %, wherein the non-tropical ingredients are selected from the plant family of Fabaceae, in particular from the sub-family Papilionoideae, and from the sub-family Caesalpinioideae, from the plant family of Poaceae, in particular from the sub-family Pooideae, from the plant family of Moraceae, from the plant family of Vitaceae, in particular from the sub-family Vitoideae, from the plant family of Asteraceae, in particular from the sub-family Cichorioideae, and combinations thereof, and 0-8 wt. % natural non-tropical flavours, wherein all weight percentages are based on a total weight of the coffee bean. In principle separate roasted extrudates could be used, which extrudates are thereafter mixed and homogenized, as an alternative. Natural flavour are known as edible aroma compounds that are found in nature, such as in plants, animals, enzymes, and microorganisms, or produced thereby, and are therefore not produced by human beings. In nature they therefore always are present with other natural substances that also may be flavour. Natural flavours can be isolated on industrial scale, to be used as an additive. The present inventors in particular make use of natural flavours obtained from organisms in nature, in particular from non-tropical plants if available, and/or from microorganisms. Tropical vegetation is any vegetation in tropical latitudes, whereas the non-tropical vegetation is found elsewhere, in so far as applicable. Although tropical vegetation might occur outside tropical latitudes, and vice versa, in particular due to climate change and human intervention, the terms are normally interpreted as above. Some important aspects in view mimicking coffee beans are the present extrudate comprising at least two non-tropical ingredients, therewith reducing an impact on the environment, the roasting thereof, the mixing and blending thereof, and the control of the particle sizes within the specific size limits. As a result of the extrusion process, the proteins and reducing sugars of the individual ingredients are now blended in such a way that they can inter-react via Maillard reactions in the roasting process following the extrusion process, as well that the Stecker degradation reaction can take place between molecules of individual ingredients.

In a second aspect the present invention relates to a method of forming a coffee bean. substitute according to the invention, comprising providing a mixture of at least two non-tropical ingredients, wherein the non-tropical ingredients are selected from the plant family of Fabaceae, in particular from the sub-family Papilionoideae, and from the sub-family Caesalpinioideae, from the plant family of Poaceae, in particular from the sub-family Pooideae, from the plant family of Moraceae, from the plant family of Vitaceae, in particular from the sub-family Vitoideae, from the plant family of Asteraceae, in particular from the sub-family Cichorioideae, and combinations thereof, and 0-8 wt. % natural non-tropical flavours, mixing said mixture into a blend, optionally modifying a moisture content of the blend, such as increasing to 15-22 wt. % before extrusion, in particular 18-19 wt. %, and after extrusion to 10-15 wt. %, such as 12-13 wt. %, in particular by adding or removing water, optionally adding caffeine to the blend, feeding the blend into an extruder, in particular under a pressure of >1 MPa, in particular under a pressure of 5-35 MPa, and/or at a temperature of >80° C., in particular at a temperature of 90-170° C., therewith forming a thick liquid, which is also referred to as plastifying, in particular, in the extruder providing intense blending and providing an extrudate, cutting the extrudate in particular into parts of <20 mm, in particular <10 mm, such as 1-8 mm, optionally grounding said mixture, in particular to a mixture with an average particle size of the mixture of at least two non-tropical ingredients is 0.1-2 mm with a standard deviation <0.2* average particle size, and optionally forming the cut extrudate into forms with a weight of 0.1-3 gr, in particular 0.3-2 gr, such as 1.0-1.5 gr.

Advantages of the present description are detailed throughout the description.

### DETAILED DESCRIPTION OF THE INVENTION

In an exemplary embodiment of the present dry coffee bean substitute the non-tropical ingredients are selected from the plant tribe Genisteae, such as Lupinus polyphyllus, from the plant genus Hordeum, such as Hordeum vulgare, from the plant genus Secale, such as Secale cereale, from the plant genus Cicer, such as Cicer arietinum, from the plant genus Ficus, in particular from the Subgenus F. subg. Ficus, such as Ficus carica, from the plant genus Ceratonia, such as Ceratonia siliqua, from the plant genus Vitis, from the plant tribe Cichorieae, in particular from the plant Cichorium, such as Cichorium intybus, and combinations thereof, and optionally selected from the plant family of Ericaceae, in particular from the plant genus Vaccinium, more in particular from the plant section Cyanococcus such as blueberry, and from the plant sub-genus Vaccinium oxycoccus such as cranberry, from the plant family of Grossulariaceae, in particular from the plant genus Ribes, more in particular from the Ribes nigrum such as blackcurrant, from the plant family of Rosaceae, in particular from the plant genus Rubus, more in particular from the plant sub-genus Rubus such as blackberry, each of these further ingredients individually may be present in an amount of in particular 0-5 wt. %, more in particular 0.1-3.5 wt. %, even more in particular 0.3-3 wt. %, such as 2-3 wt. %.

In an exemplary embodiment of the present dry coffee bean substitute the non-tropical ingredients are selected from non-tropical ingredients as such, from non-tropical ingredients in malted form, and combinations thereof.

In an exemplary embodiment of the present dry coffee bean substitute the non-tropical ingredients are selected from non-tropical ingredients as such as such, from parts of the non-tropical ingredients, such as a skin thereof, or extracts thereof, in particular grape skin, and juice, and combinations thereof. In an exemplary embodiment of the present dry coffee bean substitute, if non-tropical ingredients are not available as such, in an alternative, less preferred, tropical ingredients may be used, such as juices of plant material.

In an exemplary embodiment of the present dry coffee bean substitute the coffee bean substitute is in the form of a bean with a weight of 0.1-3 gr, in particular 0.5-2 gr, such as 1.0-1.5 gr, or in the form of a capsule with a content of 2-10 gr, in particular 5.5-7.5 grams.

In an exemplary embodiment of the present dry coffee bean substitute the coffee bean substitute is a roasted coffee bean, in particular roasted at a roast temperature of 70-350° C., more in particular 120-180° C., and/or during a roast time of 1-60 minutes, more in particular 5-30 minutes.

In an exemplary embodiment the present dry coffee bean substitute further comprises 0.01-2 wt. % caffeine (CAS 58-08-2).

In an exemplary embodiment of the present ground dry coffee bean substitute the coffee bean comprises particles with an average particle size of the blend of at least two non-tropical ingredients is 0.1-2 mm with a standard deviation <0.2* average particle size, in particular 0.15-0.5 mm, more in particular 0.25-0.4 mm, preferably with a standard deviation <0.15* average particle size.

In an exemplary embodiment the present dry coffee bean substitute comprises at least three non-tropical ingredients, in particular at least four non-tropical ingredients, such as five or more, wherein the non-tropical ingredients are selected from the genus Hordeum, such as Hordeum vulgare, such as barley, from the genus Secale, such as Secale cereale, such as rye, from the plant tribe Genisteae, in particular form the genus Lupinus, such as Lupinus polyphyllus, such as lupin, from the plant tribe Cichorieae, in particular from the plant genus Cichorium, such as Cichorium intybus,, such as chicory, with the proviso that the non-tropical ingredients are selected from different genus,

[symbol]

in particular comprising 1-40 wt. % of the genus Hordeum, in particular 5-38 wt. %, more in particular 15-35 wt. %, even more in particular 18-33 wt. %, such as 20-32 wt. %, 1-40 wt. % of the genus Secale, in particular 5-38 wt. %, more in particular 15-35 wt. %, even more in particular 18-33 wt. %, such as 20-32 wt. %, 1-40 wt. % of the plant tribe Genisteae, in particular 5-38 wt. %, more in particular 15-35 wt. %, even more in particular 18-33 wt. %, such as 20-32 wt. %, wherein for capsules the percentages are relatively lower, such as 20-24 wt. % for the above ingredients each individually, wherein for filters the percentages are relatively higher, such as 23-27 wt. % for the above ingredients each individually, and 1-15 wt. % of the plant tribe Cichorieae, in particular 2-13 wt. %, more in particular 5-12 wt. %, even more in particular 7-10 wt. %, such as 8-9 wt. % for filter and 7-8 wt. % for capsules.

In an exemplary embodiment the present dry coffee bean substitute comprises 0.1-4 wt. % non-tropical flavours, in particular wherein the flavours are selected from molecules comprising at least one of a furan, a phenol, a pyrrole, a pyrazine, an aldehyde, a ketone, and an alcohol, in particular with the proviso that the natural flavour is not obtained from a coffee bean, that is, from another natural origin, such as a plant, in particular a non-tropical plant, or from a microorganism.

In an exemplary embodiment the present method further comprises roasting the extrudate a roast temperature of 70-350° C., and/or during a roast time of 1-60 minutes, such as roasting in a drum roaster or in a hot air roaster. The moisture content may thereby be reduced to 2-10 wt. %, such as 3-7 wt. %. The roasting is typically performed before grounding.

In an exemplary embodiment the present method further comprises grounding the roasted particles into a coffee substitute, in particular wherein the coffee substitute is selected from a filter substitute, a pour over/drip substitute, a French press substitute, a percolate substitute, a capsule substitute, and an espresso substitute.

The invention will hereafter be further elucidated through the following examples which are exemplary and explanatory of nature and are not intended to be considered limiting of the invention. To the person skilled in the art it may be clear that many variants, being obvious or not, may be conceivable falling within the scope of protection, defined by the present claims.

### EXAMPLES

### Blend Composition

lupin (23.5 w/w %), (malted) rye (23.5 w/w %), (malted) barley (23.5 w/w %), chickpeas (10 w/w %), figs 11% w/w), chicory (8 w/w %), berries (2 w/w %) and carob (3.5 w/w %) into a course mixture.
Grind the unroasted single ingredients and mix into a coarse blend containing particles between 0.5-4 mm;
Add water to the mixture to obtain a water content between 12-20 w/w %;
Add specific flavour compound precursors in the form of specific proteins, amino acids and reducing sugars;
The mixture is fed into a mono-screw extruder, where the raw materials are mixed in a very intense way on a molecular level, in such a way that Maillard reaction & Strecker degradation can take place between the molecules of the individual ingredients. The ingredients fluidize under the enormous pressure created by the extruder. Partly these reaction take place in the extruder, but they also continue/start during the roasting step;
Using specific blades, the extrudate is cut into a green coffee bean shape and size;
Roast the extrudate in a hot-air or drum roaster until colour a dark brown has been formed. Generally, roasting temperatures are between 180-250° C. and roasting times between 5-25 minutes depending on the composition, size and weight of the extrudate;
After roasting, specific flavour compounds and/or caffeine can be sprayed onto the coffee bean substitutes;
The roasted extruded particle can be ground like conventional coffee and used for all types of coffee brewing methods.

1. Dry coffee bean substitute, comprising
>90 wt. % of at least one roasted extrudate, the extrudate comprising >90 wt. % plant material, 0-10 wt. % of material from or produced by microorganisms, and 0-10 wt. % of at least one chemical compound, wherein the extrudate is of a homogenized blend of at least two non-tropical ingredients, wherein the non-tropical ingredients are selected from the plant family of Fabaceae, and from the sub-family Caesalpinioideae, from the plant family of Poaceae, from the plant family of Moraceae, from the plant family of Vitaceae, from the plant family of Asteraceae, and combinations thereof, wherein the at least two plant ingredients are selected from at least two different plant families, and
0-8 wt. % natural non-tropical flavours,
wherein all weight percentages are based on a total weight of the coffee bean substitute.

2. Coffee bean substitute according to claim 1, wherein the non-tropical ingredients are selected from the plant tribe Genisteae, from the plant genus Hordeum, from the plant genus Secale, from the plant genus Cicer, from the plant genus Ficus, from the plant genus Ceratonia, from the plant genus Vitis, from the plant tribe Cichorieae, and combinations thereof,
and selected from the plant family of Ericaceae, and from the plant sub-genus Vaccinium oxycoccus, from the plant family of Grossulariaceae,
from the plant family of Rosaceae.

3. Coffee bean substitute according to claim 1, wherein the non-tropical ingredients are selected from non-tropical ingredients as such, from non-tropical ingredients in malted form, from non-tropical ingredients in fermented form, and combinations thereof.

4. Coffee bean substitute according to claim 1, wherein the non-tropical ingredients are selected from non-tropical ingredients as such, from parts of the non-tropical ingredients, extracts thereof, and combinations thereof.

5. Coffee bean substitute according to claim 1, wherein the form of the coffee bean substitute is selected from a bean with a weight of 0.1-3 gr, and from a capsule with a content of 2-10 gr.

6. Coffee bean substitute according to claim 1, wherein the coffee bean substitute is a roasted coffee bean, at a roast temperature of 70-350° C., and during a roast time of 1-60 minutes.

7. Coffee bean substitute according to claim 1, further comprising 0.01-2 wt. % caffeine (CAS 58-08-2).

8. Coffee bean substitute according to claim 1, wherein a ground coffee bean comprises particles with an average particle size of the blend of at least two non-tropical ingredients is 0.1-2 mm with a standard deviation <0.2* average particle size.

9. Coffee bean substitute according to claim 1, comprising at least three non-tropical ingredients, wherein the non-tropical ingredients are selected from the genus Hordeum, from the genus Secale,
from the plant tribe Genisteae, from the plant tribe Cichorieae, with the proviso that the non-tropical ingredients are selected from different genus, comprising
1-40 wt. % of the genus Hordeum,
1-40 wt. % of the genus Secale,
1-40 wt. % of the plant tribe Genisteae, and
1-15 wt. % of the plant tribe Cichorieae, and
0-10 wt. % water.

10. Coffee bean substitute according to claim 1, comprising 0.1-4 wt. % non-tropical flavours, wherein the flavours are selected from molecules comprising at least one of a furan, a phenol, a pyrrole, a pyrazine, an aldehyde, a ketone, and an alcohol, with the proviso that the natural flavour is not obtained from a coffee bean.

11. Method of forming a coffee bean substitute according to claim 1, comprising
providing a mixture of at least two non-tropical ingredients, wherein the non-tropical ingredients are selected from the plant family of Fabaceae, and from the sub-family Caesalpinioideae, from the plant family of Poaceae from the plant family of Moraceae, from the plant family of Vitaceae, from the plant family of Asteraceae, and combinations thereof, and
0-8 wt. % natural non-tropical flavours,
mixing said mixture into a blend,
feeding the blend into an extruder, under a pressure of >1 MPa, and at a temperature of >80° C., therewith forming a thick liquid,
in the extruder providing intense blending and providing an extrudate,
cutting the extrudate in particular into parts of <20 mm,
grounding said mixture to a mixture with an average particle size of the mixture of at least two non-tropical ingredients is 0.1-2 mm with a standard deviation <0.2* average particle size, and
forming the cut extrudate into forms with a weight of 0.1-3 gr.

12. Method of forming a coffee bean substitute according to claim 11, further comprising
roasting the extrudate a roast temperature of 70-350° C., and during a roast time of 1-60 minutes.

13. Method of forming a coffee bean substitute according to claim 11, further comprising
grounding the roasted particles into a coffee substitute, wherein the coffee substitute is selected from a filter substitute, a pour over/drip substitute, a French press substitute, a percolate substitute, a capsule substitute, and an espresso substitute.

14. (canceled)

15. Coffee bean substitute according to claim 1, wherein the non-tropical ingredients are selected from the the sub-family Papilionoideae, and from the sub-family Caesalpinioideae, from the sub-family Pooideae, from the sub-family Vitoideae, and from the sub-family Cichorioideae.

16. Coffee bean substitute according to claim 1, wherein a ground coffee bean comprises particles with an average particle size of the blend of at least two non-tropical ingredients is 0.15-0.5 mm, with a standard deviation <0.15* average particle size.
